(19) United States
(12) Patent Application Publication
(10) Pub. No.: US 2026/0279059 A1
(43) Pub. Date: Sep. 17, 2026

(54) MEASURING APPARATUS, MEASURED DATA UTILIZATION SYSTEM, AND ACQUISITION METHOD OF MEASURED DATA

(71) Applicant: Hitachi High-Tech Corporation, Minato-ku, Tokyo (JP)

(72) Inventors: Keiichi MITANI, Tokyo (JP); Kohei SATO, Tokyo (JP); Naohito IKEDA, Tokyo (JP); Takashi NUMATA, Tokyo (JP); Ryota KAWAMATA, Tokyo (JP)

(21) Appl. No.: 19/166,690

(22) PCT Filed: Mar. 7, 2024
(86) PCT No.: PCT/JP2024/008642

§ 371 Date: Sep. 18, 2025

(51) Int. Cl. G06V 20/52; G06T 7/70; G06V 10/25

(52) U.S. Cl. CPC G06V 20/52; G06T 7/70; G06V 10/25; G06V 2201/07

(57) ABSTRACT

A measuring apparatus for acquiring measurement data obtained by measuring a maintenance work for a semiconductor manufacturing device by a worker by using a 3D sensor mounted in a space where the maintenance work is performed. The measuring apparatus includes an object identifying unit for identifying an object included in an image of raw data acquired from the 3D sensor; a coordinate transforming unit for obtaining a position in the space of the identification object; a work determining unit for determining a work process executed by the worker on the basis of movements of one or more identified objects; a region setting unit for setting a region which is permitted/prohibited to be output in accordance with the work process; and a data limiting unit for generating limited data obtained by making a region which is prohibited to be output invisible in the image of the raw data.

### TECHNICAL FIELD

This invention relates to a measuring apparatus, a measured data utilization system, and an acquisition method of measured data.

### BACKGROUND ART

For improvement in productivity of a semiconductor device, a semiconductor manufacturing apparatus is required to improve not only its productivity but also the operation rate. Since many of maintenance works of a semiconductor manufacturing apparatus include manual works, a maintenance work has to be performed efficiently and appropriately. To prevent a rework in a maintenance work, for example, a system for accumulating and analyzing logs of maintenance works performed by workers is considered to be effective. In this case, to quantitatively characterize a maintenance work, logs of how each of workers moves for an apparatus and a part have to be also accumulated. Examples include motions of hands of wiping a part while holding it at the time of wiping the part, the positional relation of both hands at the time of attaching a part, the ways of moving hands at the time of detaching/attaching a large-sized part, and the relation between a worker working in an apparatus and a worker making preparation in the surrounding area.

Patent Literature 1 relates to a technique of restricting an image so as to conceal a region other than a region of a monitoring target. In the case of remotely assisting a work such as a maintenance on a monitoring target, a worker sends an image obtained by capturing the monitoring target to a terminal device in a remote place, and an instructor recognizes the image and assists the work of the worker by the terminal device. In the case where there is secrete information which is desired not to be seen by the instructor around the monitoring target, the technique of Patent Literature 1 enables a remote assistance while concealing the information.

### CITATION LIST

### Patent Literature

Patent Literature 1: Japanese Unexamined Patent Application Publication No. 2022-184481

### SUMMARY OF INVENTION

### Technical Problem

In recent years, the ranging technology is making progress and, by using a 3D sensor, a spatial action of a worker for an apparatus can be measured at an actual dimension level.

In Patent Literature 1, a substrate treatment apparatus is illustrated as a monitoring target. Such an apparatus is mounted in a factory of the user, and a maintenance work on the apparatus is often performed in a place full of confidential information which is not related to apparatuses of other companies and other maintenance works. Further, in a maintenance work, it frequently occurs that a part is detached from an apparatus as a target of a maintenance work, and a work is performed in a place different from the mounting place of the apparatus. Consequently, it is insufficient to fixedly monitor only a monitoring target like in Patent Literature 1.

Generally, moving among work places frequently occurs in a maintenance work, so that measurement data in which the movement of a part or a worker is traced has to be obtained. However, there is the possibility that information which is not allowed to be shown is acquired unintentionally in the process, and it accompanies a risk of information leakage.

Further, since the data amount of a 3D sensor is large, it is unpreferable from the viewpoint of data capacity to continue data acquisition in a state where no change continues for long time even in a region in which data acquisition is possible.

### Solution to Problem

A measuring apparatus according to an embodiment of the present invention is a measuring apparatus for acquiring measurement data obtained by measuring a maintenance work for a semiconductor manufacturing apparatus by a worker by using a first 3D sensor mounted in a space in which the maintenance work is performed, and the measuring apparatus includes: an object identifying unit for identifying an object included in an image of raw data acquired from the first 3D sensor; a coordinate transforming unit for obtaining a position in a space of an identification object identified by the object identifying unit; a work determining unit for determining a work process executed by the worker on the basis of movements of one or more identified objects; a region setting unit for setting a region which is permitted/prohibited to be output in the image of the raw data in accordance with the work process determined by the work determining unit; and a data limiting unit for generating limited data obtained by making the region which is prohibited to be output by the region setting unit invisible in the image of the raw data.

### Advantageous Effects of Invention

A measuring apparatus, a measured data utilization system, and an acquisition method of measured data, capable of acquiring small data capacity of measurement data at low information leakage risk are provided. Objects and novel feature other than the above will be apparent from the description of the present specification and accompanying drawings.

### BRIEF DESCRIPTION OF DRAWINGS

FIG. 1 is a diagram illustrating a space in which a worker performs a maintenance work.

FIG. 2A illustrates a hardware configuration example of an information processing apparatus.

FIG. 2B is a functional block diagram of measuring functions of a data processing apparatus.

FIG. 3 illustrates a flow of a maintenance work for a gate valve.

FIG. 4A is a diagram illustrating data which is loaded in a data storing unit.

FIG. 4B illustrates an example of ROIs which are set in a virtual space.

FIG. 4C illustrates a data configuration example of a work process table.

FIG. 5 illustrates an example of a gate valve detaching process.

FIG. 6 is a diagram illustrating a method of narrowing an ROI using a gate valve model as a reference.

FIG. 7 illustrates an example of an assembling process of an upper chamber.

FIG. 8 illustrates an example of a disassembling process of the upper chamber.

FIG. 9 illustrates a configuration example of a measured data utilization system.

### DESCRIPTION OF EMBODIMENTS

A present embodiments will be described below with reference to the drawings.

### First Embodiment

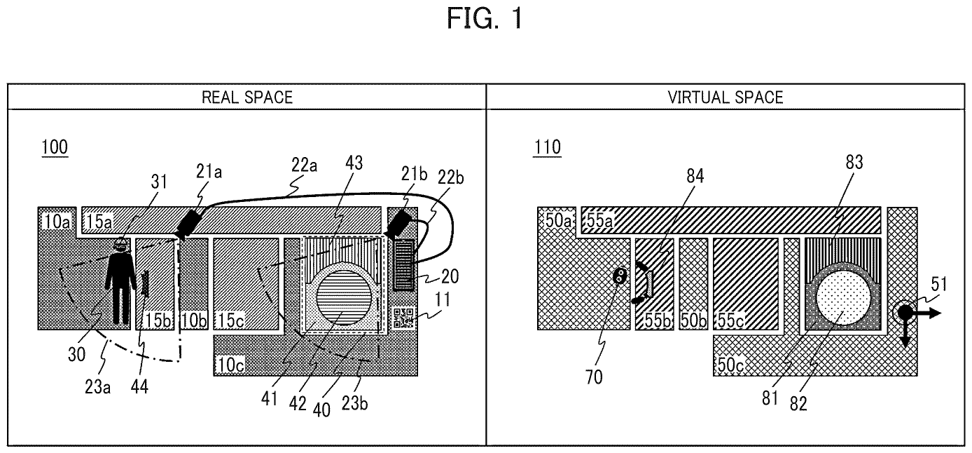

FIG. 1 illustrates a space in which a worker performs a maintenance work on a semiconductor manufacturing apparatus in a first embodiment. A real space 100 illustrated on the left side of FIG. 1 is a top view schematically illustrating a space in which a worker performs a maintenance work (only the worker is illustrated in a side view for the convenience of drawing). A semiconductor manufacturing apparatus 40 is a target of the maintenance work, and a path 10 and a work area 15 are provided around it. Each of the path and the work area is divided into a plurality of sections. In the case of referring to a path or a work area in a specific section, a reference character will be allocated. An etcher is illustrated as an example of the semiconductor manufacturing apparatus 40. In the diagram, a base plate 41, a lid 42, and a valve box 43 are illustrated.

At the time of a maintenance work, for example, a worker 30 detaches a gate valve of the semiconductor manufacturing apparatus 40, concretely, takes out a gate valve 44 from the valve box 43, moves it to any of the work areas (in this example, a work area 15b) in accordance with the situation at that time, and performs the maintenance work on the gate valve 44. To measure such a work of the worker by a 3D sensor 21, one or more 3D sensors 21 are fixedly mounted in the real space 100 so that spaces having the possibility that a worker works can be observed. In the case of providing a plurality of 3D sensors, it is desirable to mount them so that observation ranges of adjacent 3D sensors overlap. With respect to the 3D sensors as well, a reference character is allocated to refer to a specific 3D sensor. In this example, a 3D sensor 21a is disposed so that the work in the work area 15b is included in a visual field 23a, and a 3D sensor 21b is disposed so that the work on the semiconductor manufacturing apparatus 40 is included in a visual field 23b. The 3D sensor 21 is connected to a data processing apparatus 20 via a cable 22. In this example, the worker 30 wears an HMD (Head Mounted Display) 31. The HMD 31 also has the function of a 3D sensor.

The data processing apparatus 20 has the functions of receiving measured data (raw data) from the 3D sensor 21 or the HMD 31 and limiting a visible region in accordance with a work process executed by the worker, in an image of the measured data. Hereinafter, measured data in which a visible region is limited will be called limited data. The data processing apparatus 20 does not have to be disposed within the real space 100 but may be disposed on the outside of the real space 100.

The data processing apparatus 20 holds a space model corresponding to the real space 100 in order to generate limited data. A virtual space 110 indicated by the space model is illustrated on the right side of FIG. 1. In the virtual space 110, the path 10 corresponds to a path model 50, the work area 15 corresponds to a work area model 55, the base plate 41, the lid 42, the valve box 43, and the gate valve 44 correspond to a base plate model 81, a lid model 82, a valve box model 83, and a gate valve model 84, respectively, and the worker 30 corresponds to a worker model 70. In the example of the virtual space 110 illustrated in FIG. 1, the path 10 and the work area 15 are modeled as they are in accordance with the layout. However, simplification may be performed or the sections such as the path model 50 and the work area model 55 may be omitted. A coordinate criterion 51 indicates the origin of a world coordinate system of the virtual space. To associate the virtual space 110 and the real space 100 with each other, a marker 11 is provided in the position in the real space 100 corresponding to the coordinate criterion 51 of the virtual space 110. As the marker 11, for example, a two-dimensional barcode or a recognizable pattern may be displayed on the floor surface, or a tape can be put.

The size of the real space 100 for which a space model is created may be determined according to a maintenance work to be measured. In the above-described example, it is unnecessary to model the entire building but it is sufficient to model the range in which there is the possibility that a worker works as the virtual space 110.

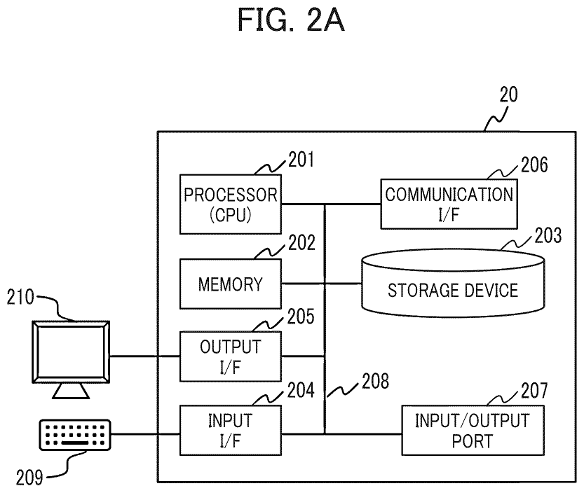

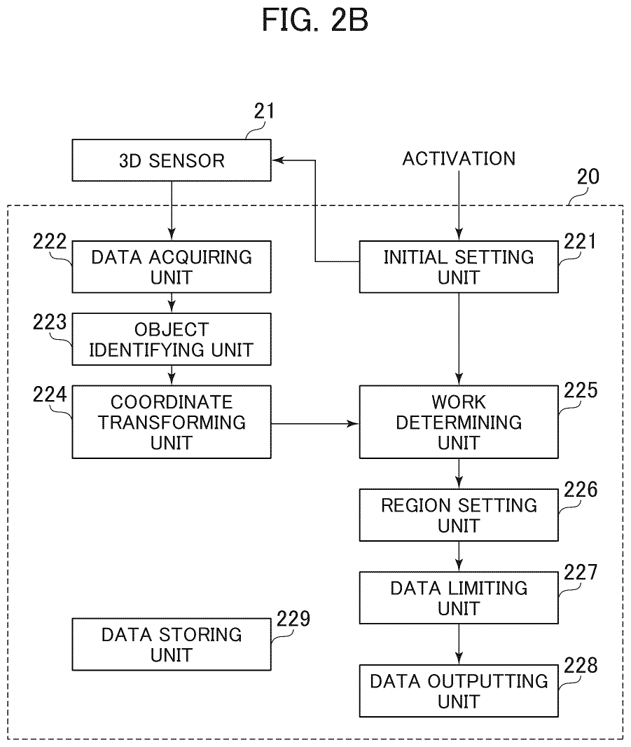

FIG. 2A illustrates a hardware configuration example of the data processing apparatus 20. The data processing apparatus 20 is realized by an information processing apparatus including, as main components, a processor (CPU) 201, a memory 202, a storage device 203, an input interface (I/F) 204, an output I/F 205, a communication I/F 206, an Input/output port 207, and a bus 208 as illustrated in FIG. 2A. By executing a process in accordance with a program loaded in the memory 202, the processor 201 functions as a function unit (function block) providing a predetermined function. The storage device 203 stores data and a program used by the function unit. As the storage device 203, for example, a nonvolatile storage medium such as an HDD (Hard Disk Drive) or an SSD (Solid State Drive) is used. The input I/F 204 is an interface connecting an input device 209 such as a keyboard or a pointing device, and the output I/F 205 is an interface connecting a display device 210. The communication I/F 206 enables communication with another information processing apparatus via a network. To the input/output port 207, the cable 22 of the 3D sensor 21 is connected, and measured data from the 3D sensor 21 is input. Those components are connected by the bus 208 so that they can communicate with one another.

The data processing apparatus 20 does not have to be realized by a single information processing apparatus but may be realized by a plurality of information processing apparatuses. Further, a part or all of the functions of the data processing apparatus 20 may be realized as an application in the cloud.

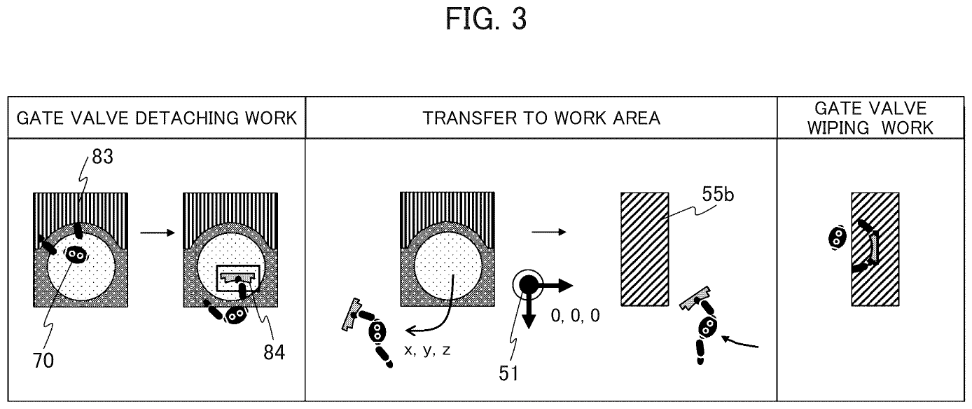

FIG. 2B is a functional block diagram of the measuring function of the data processing apparatus 20. The function has an initial setting unit 221, a data acquiring unit 222, an object identifying unit 223, a coordinate transforming unit 224, a work determining unit 225, a region setting unit 226, a data limiting unit 227, a data outputting unit 228, and a data storing unit 229 storing data necessary for the measuring function. The details of those components will be described later using a maintenance work on a gate valve illustrated in FIG. 3 as an example. The maintenance work includes a gate valve detaching work performed near the semiconductor manufacturing apparatus 40 and a gate valve wiping work performed in the work area. Since the measuring function of the data processing apparatus 20 according to the embodiment can flexibly limit a visible region in an image of raw data, measured data of a maintenance work, which does not include confidential information in the building in which the semiconductor manufacturing apparatus 40 is mounted can be acquired and shared with the third party without the risk of leak of a secret.

### Initial Setting Unit 221

The initial setting unit 221 activates the 3D sensor 21. An example of using a LiDAR (Light Detection And Ranging) type camera as the 3D sensor 21 is illustrated here. The LiDAR type camera can output RGB (color) image data and, in addition, depth image data indicating the distance to a target. As the 3D sensor 21, a sensor obtaining measured data which can be converted to three-dimensional data (point cloud data or volume data of mesh, voxel, or the like) is sufficient. The 3D sensor 21 is not limited to a LiDAR type camera but may be a stereo camera provided with two CMOS image sensors, a sensor of a structured light type in which a pattern light emitting device for projection and an image sensor are combined, a combination of a distance sensor and an RGB camera, a sensor device in which the relations among pixels are adjusted, or the like. Further, a sensor having the function of estimating distance information among pixels from an RGB image by using machine learning or the like may be used.

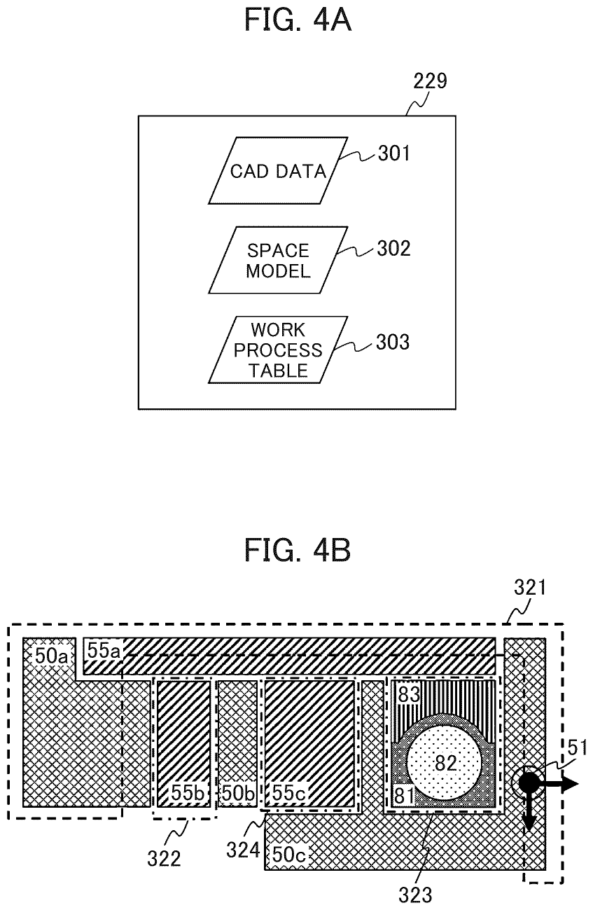

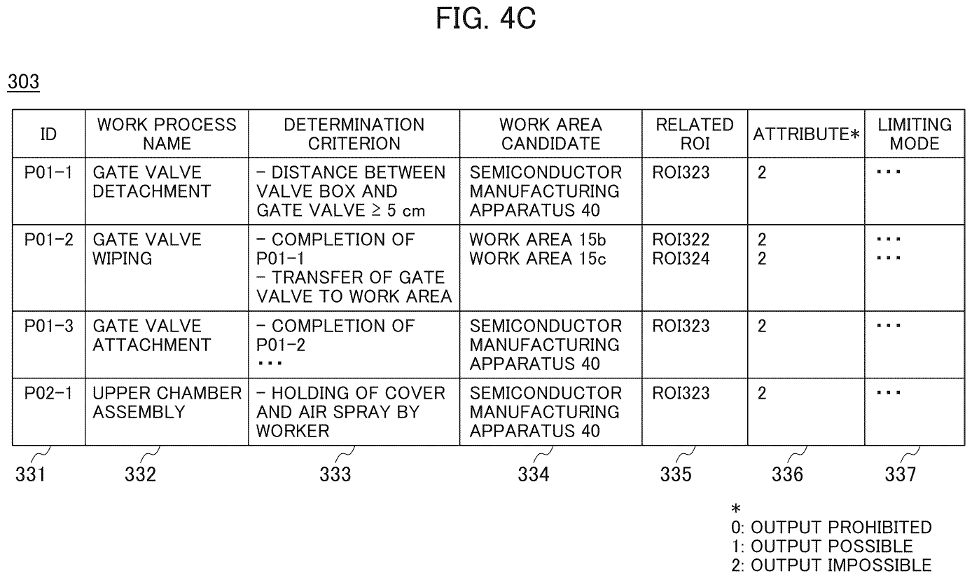

The initial setting unit 221 reads data for executing the measuring function and performs initialization. FIG. 4A illustrates data which is loaded in the data storing unit 229. CAD data 301 is CAD data of an apparatus as a target of the maintenance work, which is the semiconductor manufacturing apparatus 40 in this example. Space model 302 is a model of the real space in which the worker performs the maintenance work described with reference to FIG. 1. In the space model 302, a region having attribute information regarding whether an image of raw data can be output or not (hereinafter, described as ROI (Region of Interest)) is set. FIG. 4B illustrates an example of an ROI which is set in the virtual space expressed by the space model 302. The attribute information of the ROI is set to three attributes of “output possible”, “output impossible”, and “output prohibited”. For example, an ROI 321 is a region having the “output prohibited” attribute and in which output of measured data is always prohibited. ROIs 322, 323, and 324 are regions having the “output possible”/“output impossible” attributes, in which output of measured data can be permitted on the basis of determination of the data processing apparatus 20. It is assumed that all of the ROIs are set to “output impossible” or “output prohibited” in the initial state.

Setting of an ROI to the space model will now be described. It is unnecessary to partition an ROI in accordance with the path 10 and the work area 15 illustrated in FIG. 1. For example, in FIG. 4B, a part of a work area model 55a is “output prohibited” by the ROI 321. For example, in the case where a metal face or a mirror is provided for the wall face of a work area 15a corresponding to the work area model 55a, there is the possibility that unintended information is reflected in the metal face or the mirror, and is included in measurement data and leaked. To prevent such a situation, the ROI 321 having the “output prohibited” attribute can be set in a part of the work area model 55a corresponding to the wall face of the work area 15a. A work area 55b is illustrated as one ROI (ROI 322) but, for example, may be divided into a plurality of ROIS. Setting can be made in accordance with the actual use in the real space. It is sufficient to set an ROI having the “output possible”/“output impossible” attribute so as to cover the entire vision field of the 3D sensor mounted in the real space. An ROI having the “output prohibited” attribute is set for the entire virtual space regardless of the disposition of the 3D sensor mounted in the real space. The reason is that measurement data of a mobile 3D sensor like the HMD 31 can be also limited.

In a work process table 303, information of a work process of a maintenance work to be measured is registered. FIG. 4C illustrates a data configuration example of the work process table 303. In ID 331, an ID for identifying a work process is registered. In work process name 332, the name of a work process is registered. In determination criterion 333, a determination criterion for determining that the work process is executed from measurement data of the 3D sensor or the like is registered. In work area candidate 334, a work area candidate in which the work process is to be executed is registered. The number of work area candidates is single or plural. In related ROI 335, an ROI corresponding to the work area candidate is registered. In attribute 336, the attribute of the related ROI is registered. As described above, in the initial setting by the initial setting unit 221, an ROI having the “output possible”/“output impossible” attribute is registered as “output impossible”. In limiting mode 337, a mode in the case of limiting an image of raw data is registered. There are various limiting modes. For example, there is a mode of blurring or blacking out an image region which is made invisible.

### Data Acquiring Unit 222

The data acquiring unit 222 performs a data process so that measured data (raw data) received from the 3D sensor 21 can be processed by the object identifying unit 223. Concretely, the data acquiring unit 222 makes the angle of view of RGB image data and that of depth image data obtained from the 3D sensor 21 match, and obtains a camera parameter for specifying the position of an object included in the image data in the world coordinate system using the coordinate criterion 51 as the origin. The camera parameter includes an inside-camera parameter and an outside-camera parameter. The inside-camera parameter is a parameter for camera calibration including a lens distortion and the positional relation between the RGB sensor and the distance sensor in the 3D sensor 21. The outside-camera parameter is a parameter indicating the position and the posture of the 3D sensor 21 mounted in the world coordinate system. In the case where the inside-camera parameter is stored in a built-in memory of the 3D sensor 21, the inside-camera parameter is obtained from the 3D sensor 21. In the other case, by performing calibration in advance, the inside-camera parameter is generated. On the other hand, the outside-camera parameter may be set in the 3D sensor, or may be set on the basis of a setting position and a posture estimated by using a self-position estimating algorithm such as an SLAM (Simultaneous Localization and Mapping) process or the like.

The data process in the data acquiring unit 222 depends on a data processing method in the object identifying unit 223 at the post stage. In the case where object identification in the object identifying unit 223 is a 2D process, a process of matching the angles of view of the RGB image data and the depth image data is performed. On the other hand, in the case where the object identification in the object identifying unit 223 is a 3D process, the RGB image data and the depth image data whose angles of view are matched is converted to 3D data (3D point cloud data) in the virtual space by using the camera parameter.

### Object Identifying Unit 223

The object identifying unit 223 performs an object identifying process by using image data or 3D data processed by the data acquiring unit 222 and the camera parameter. The object identifying process may be performed in any of the 2D process and the 3D process, and a known method can be used. The object identifying unit 223 extracts an object (identified object) identified by the object identifying process as 3D data. Identification information is given to each of identified objects extracted.

### Coordinate Transforming Unit 224

The coordinate transforming unit 224 transforms the 3D data of the extracted identified object to the world coordinate system by using the camera parameter. By the above-described process, the data processing apparatus 20 can grasp the identified object included in an image of raw data obtained by the 3D sensor 21 together with the position in the virtual space.

### Work Determining Unit 225

By continuously executing the above-described process on measured data from the 3D sensor 21, the data processing apparatus 20 can grasp the motion of the identified object in the virtual space. The motion of the identified object includes a transfer of the identified object in the virtual space and, in addition, a shape change of the identified object itself and the like. When the motion of one or more identified objects in the virtual space corresponds to the determination criterion 333 of the work process table 303, the work determining unit 225 detects it as the work process.

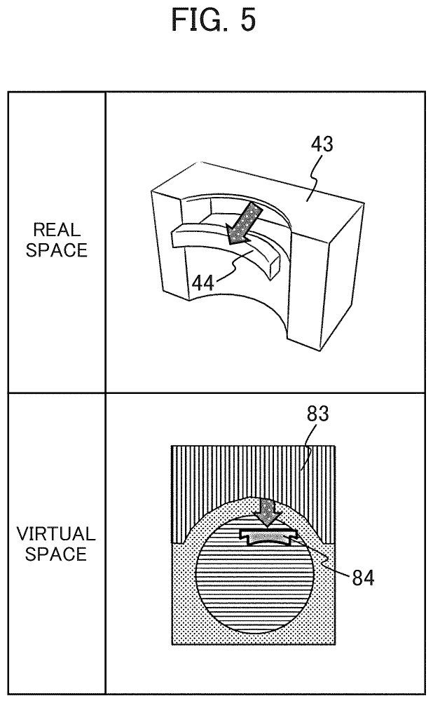

FIG. 5 illustrates an example of a gate valve detaching process. A state where the gate valve 44 is taken out from the valve box 43 in the real space is expressed as a motion that the gate valve model 84 increases with distance from the valve box model 83 in the virtual space. For example, from the track of the minimum distance between the valve box model 83 and the gate valve model 84, the flow line of the gate valve model 84 is grasped, and takeoff of the gate valve can be determined. The gate valve model 84 is an identified object extracted from image data of the 3D sensor 21. However, since the valve box model 83 is a fixed device, the shape can be grasped in advance on the basis of the CAD data 301 without extracting the model as an identified object.

The data processing apparatus 20 tracks the gate valve taken out in the gate valve detaching. In the case where a number of 3D sensors 21 are disposed in the real space, by keeping on identifying the gate valve as an identified object by the object identifying unit 223, the tracking can be performed by tracing the path in the virtual space. Alternatively, in the case where the worker 30 wears a sensor such as the HMD 31, capable of specifying the position of the worker 30, the tracking of the gate valve may be performed on the basis of the position information of the worker 30 performing a maintenance.

The work determining unit 225 traces the motion of the gate valve (identified object) in the virtual space and collates it with the determination criterion 333 of the work process table 303. In the case where the maintenance work includes a series of work processes from detachment of the gate valve to the reassembly to the valve box (refer to FIG. 4C (ID: P01-1 to P01-3)), when it is recognized that the gate valve model 84 is moved to any of ROIs registered as the related ROIs 335, the work determining unit 225 detects execution of the gate valve wiping work.

### Region Setting Unit 226

A setting of an output possible/impossible region in an image of raw data related to a gate valve wiping work will now be described as an example. The region setting unit 226 sets an output possible/impossible region in an image of raw data obtained by the 3D sensor 21. In this example, the attribute of an ROI to which the gate valve model 84 moves is switched from the output impossible in the initial state to the output possible.

In the case where an image of raw data includes a range in which an ROI having the output prohibition attribute is reflected, the output impossible region is always set. Since the 3D sensor 21 is fixed and the range in which the ROI having the output prohibition attribute is reflected is fixed in image data, the output impossible region based on the ROI having the output prohibition attribute can be set in advance.

In the case where the identified object moves in the ROI having the “output possible”/“output impossible” attribute, the simplest method is a method of switching the attribute from “output impossible” to “output possible” at the timing of the movement and, when the identified object goes out, switching the attribute again from “output possible” to “output impossible”. In addition, another condition may be added to the switching of the attribute of the ROI having the “output possible”/“output impossible” attribute. For example, after lapse of predetermined time (for example, about five seconds) since the identified object enters the ROI, the attribute is switched to “output possible”. A process for an ROI through which an object temporarily passes, not for a work, can be made unnecessary. It is also possible to preliminarily recognize the hands of a worker as identification objects and, when it is determined that the hands of the worker are apart from the gate valve, switch the attribute of the ROI from “output possible” to “output impossible”.

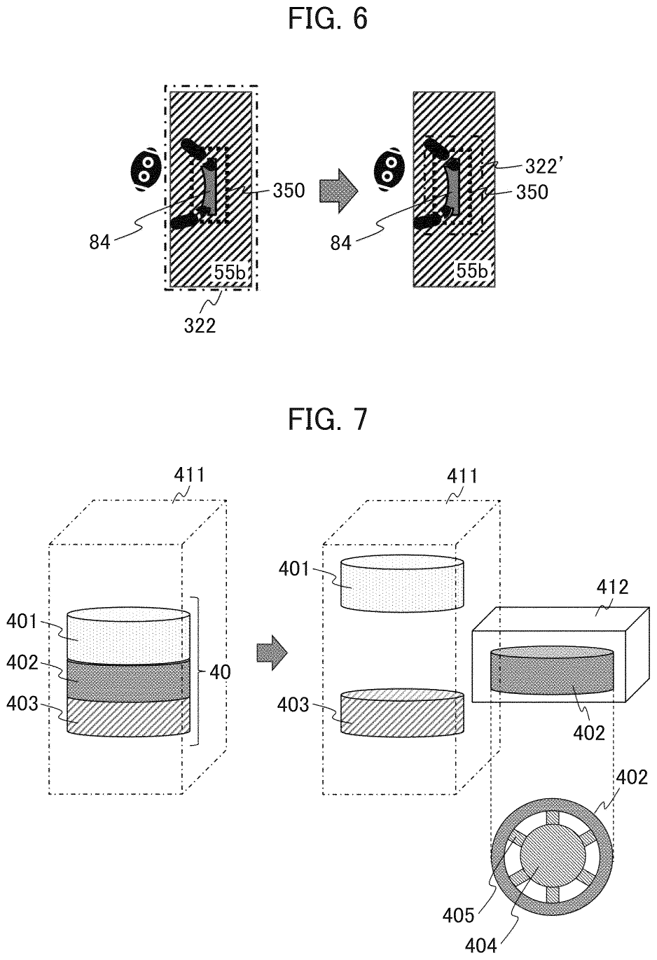

Further, in addition to the switching of the attribute of an ROI, the range of the ROI may be limited. Depending on the operation in the real space, for example, there may be a case such that another worker performs another work in the same work area, and an image of this work is “output impossible”. Consequently, an ROI is made narrowing-adjustable. FIG. 6 illustrates a method of narrowing an ROI by using the gate valve model 84 as a reference. In this example, a bounding box 350 of the gate valve model 84 is calculated, and an ROI is changed to, for example, a region enlarged by predetermined times (for example, 1.5 times) using the center of gravity of the bounding box 350 as a reference so that the hands of the worker are included. The ROI obtained by narrowing the ROI 322 is illustrated as an ROI 322′. As another method, the worker may be allowed to adjust the region of the ROI. By AR displaying the ROI in the HMD 31 worn by the worker 30 and enabling an output possible range to be designated by a hand motion, the ROI can be narrowed.

The region setting unit 226 has an edition screen for presenting an output possible/impossible setting result and a region which is visibly output to the user so that the user (information management administrator) can recognize the output possible/impossible setting made by the algorithm of the region setting unit 226 or determination of the worker, and adjusting an output region as necessary.

Further, it is preferable that the region setting unit 226 outputs, as a limitation report, the algorithm of the measuring apparatus applied to the output possible/impossible setting as described above and a log indicating edition details. For example, the limitation report includes information regarding a process of limiting measured data. Concretely, it includes information of a region which is preliminarily set as “data output impossible”, information of an object (identification object) identified as a base of determining a work process, and information of the position 41 the object or the worker holding the object, and the like. In addition, an image of raw data and an image of limitation data may be displayed for comparison.

### Data Limiting Unit 227

The data limiting unit 227 generates limited data obtained by making a partial region in an image of raw data which is made “output impossible” in the region setting unit 226 invisible. According to the limiting mode 337 in the work process table 303, for example, a process such as black-out, blurring, or deformation (a patch may be prepared or replacement with a simple figure may be performed) is performed on an output impossible region and an output prohibited region. Alternatively, the process may be divided in such a manner that the output impossible region which may be changed to “output possible” is blurred, and the output prohibited region is blacked out. When the blacked-out part is large, there is the possibility that the space recognition is disturbed. In this case, blurring or deformation may be used also for the output prohibited region.

### Data Outputting Unit 228

The limited data generated by the data limiting unit 227 is output.

### Second Embodiment

In the first embodiment, an example of performing measurement by the fixed 3D sensor has been described. In a second embodiment, an example of performing measurement by a movable 3D sensor in addition to the fixed 3D sensor will be described. A movable 3D sensor is not particularly limited. An example of using the HMD 31 worn by the worker 30 as the 3D sensor will be described here. In the case of a movable 3D sensor, different from a fixed 3D sensor, an ROI cannot be determined in advance in the virtual space.

Referring to FIG. 7, an example of an upper chamber assembling process taken in the second embodiment will be described. It is schematically illustrated that the semiconductor manufacturing apparatus 40 has a main body part 401, an upper chamber 402, and a lower chamber 403. As illustrated in the top view (schematic view) of the upper chamber 402 in the right lower part of FIG. 7, the upper chamber 402 is provided with a sample stand 404 in its center part, and has a sample stand base 405 supporting the sample stand 404. A maintenance work is, concretely, a work of disassembling the semiconductor manufacturing apparatus 40, pulling the upper chamber 402 out, and attaching a cover to the sample stand base 405.

As illustrated in the left side of FIG. 7, the semiconductor manufacturing apparatus 40 is normally constructed by integrating the main body part 401, the upper chamber 402, and the lower chamber 403 and, in this state, is included in an ROI 411 as an ROI by the fixed 3D sensor. To perform the above-described maintenance work, the main body part 401 is lifted up while the upper chamber 402 is pulled out to the side. For example, it is assumed that the upper chamber 402 is pulled out to a path 10c (refer to FIG. 1), a fixed 3D sensor whose visual field includes the path 10c is not mounted, an ROI is therefore not set, and measurement is performed by using the HMD 31 worn by the worker 30 as a 3D sensor. The process in this case will be described. In the following, a part different from the first embodiment will be mainly described.

The HMD 31 obtains RGB image data and depth data as measurement data (raw data) like the 3D sensor 21 described in the first embodiment. The measurement data of the HMD 31 is also subjected to the processes described in the first embodiment by the data acquiring unit 222, the object identifying unit 223, and the coordinate transforming unit 224, an identification object is extracted, and the position in the world coordinate system is specified.

### Work Determining Unit 225

A motion of a characteristic identification object is defined in the determination criterion 333 in the work process table 303, and an assembling work of the upper chamber 402 is determined. For example, a detection condition is set that a worker holds a cover to be attached and an air spray (refer to FIG. 4C (ID: P02-1)). When a cover, an air spray, and hands are detected and each of the cover and the air spray is less than a predetermined distance from the position of the center of gravity of the hand, the assembling work of the upper chamber 402 is determined.

### Region Setting Unit 226

In response to the determination of the work determining unit 225, for the measurement data of the HMD 31, the region setting unit 226 sets an ROI having the “output possible” attribute on the basis of the identification object of the upper chamber 402. In a manner similar to FIG. 6, a bounding box of an upper chamber model is calculated, and an ROI 412 having the “output possible” attribute obtained by enlarging the region by a predetermined number of times (for example, 1.5 times) using, for example, the center of gravity of the bounding box as a reference is set so that the hands of the worker are included in the bounding box.

In such a manner, even in a region for which a fixed 3D sensor is not mounted, measurement data can be obtained by using a 3D sensor worn by a worker and, by limiting video data to be output to only the periphery of a work target, occurrence of unintentional information leakage can be prevented. In the case of obtaining measurement data from the HMD 31 within an ROI having the “output possible” attribute, all of the region of an image of the measurement data may be set as an ROI.

### Third Embodiment

A third embodiment is also an example of using a movable 3D sensor. An example of using a 3D sensor mounted on a carriage used for carrying a large part will be described here.

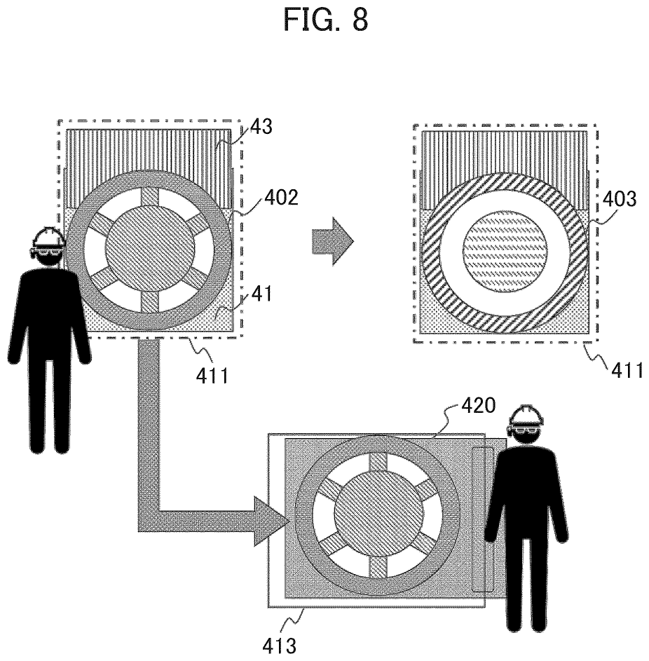

Referring to FIG. 8, an example of an upper chamber disassembling process taken in the third embodiment will be described. A worker detaches the upper chamber 402 from the lower chamber 403, and mounts the upper chamber 402 onto a carriage 420.

A 3D sensor mounted on the carriage 420 obtains RGB image data and depth data as measurement data (raw data) like the 3D sensor 21 described in the first embodiment does. The measurement data of the 3D sensor mounted on the carriage 420 is also subjected to the processes described in the first embodiment by the data acquiring unit 222, the object identifying unit 223, and the coordinate transforming unit 224, an identification object is extracted, and the position in the world coordinate system is specified.

### Work Determining Unit 225

The motion of a characteristic identification object is defined in the determination criterion 333 in the work process table 303, and a work of detaching the upper chamber 402 is determined. Detection of separation between the upper chamber 402 and the lower chamber 403 by the 3D sensor 21b is set as a first condition. When the distance between the bounding box gravity center of the upper chamber 402 and the bounding box gravity center of the lower chamber 403 becomes equal to or larger than a predetermined distance, it can be determined that they are separated. A condition of detecting that the upper chamber 402 is placed on the carriage 420 by the 3D sensor mounted on the carriage 420 is set as a second condition. For example, in the case where the distance between the top face of the carriage 420 and the bounding box gravity center of the upper chamber 402 becomes less than a predetermined distance, it can be determined that the upper chamber 402 is placed on the carriage. When the two detection conditions are satisfied, the detaching work of the upper chamber 402 is determined.

### Region Setting Unit 226

In the example, it is assumed that the field of view of the 3D sensor mounted on the carriage 420 is fixed to the top face of the carriage 420. In this case, in response to the determination of the work determining unit 225, an ROI 413 having the “output possible” attribute is set for the entire field of view of the 3D sensor mounted on the carriage 420. Alternatively, an ROI having the “output possible” attribute may be set on the basis of the bounding box of the object mounted on the top face of the carriage 420.

With the configuration, even in a region for which a fixed 3D sensor is not mounted, measurement data can be obtained by using a 3D sensor mounted on a movable object, and by limiting video data to be output to only the periphery related to a work target, occurrence of unintended information leakage can be prevented.

### Fourth Embodiment

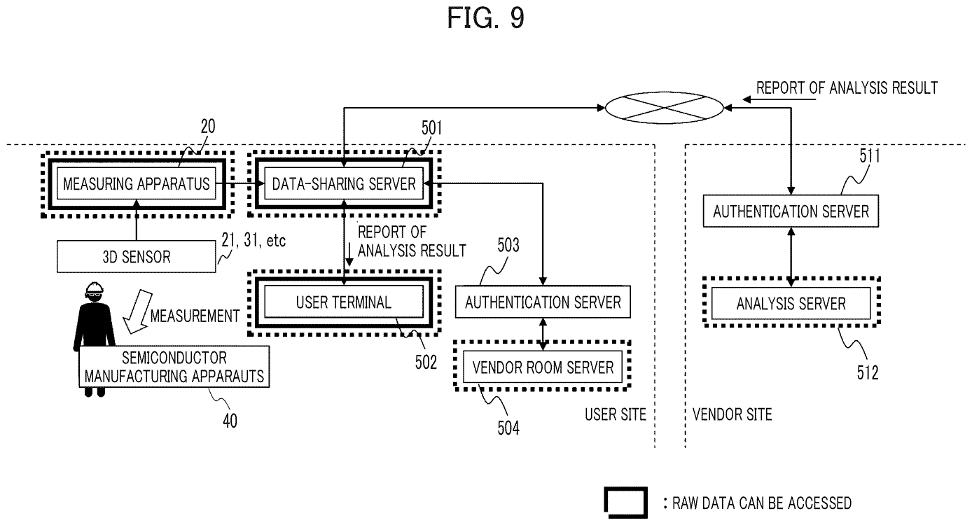

FIG. 9 illustrates a configuration example of a measured data utilization system for utilizing measurement data on a maintenance work for the semiconductor manufacturing apparatus 40, collected by the measuring apparatus (data processing apparatus 20) described in the first to third embodiments. The system is operated by a vendor as the manufacturer of the semiconductor manufacturing apparatus 40 and a user as the user of the semiconductor manufacturing apparatus 40. In FIG. 9, the left side illustrates an information processing apparatus provided in the user site, and the right side illustrates an information processing apparatus provided in the vendor site. The user site and the vendor site can communicate with each other via a network. With respect to the information processing apparatuses, apparatuses capable of accessing raw data of measurement data on a maintenance work for the semiconductor manufacturing apparatus 40 by 3D sensors are indicated by being circled with the solid-line black frames, and apparatuses capable of accessing limited data as measurement data in which a part of a region is concealed by the measuring apparatus 20 are indicated by being circled with the broken-line black frames.

The raw data, the limited data, and a limitation report collected by the measuring apparatus 20 are accumulated in a data-sharing server 501. The user having the access authority to confidential information can recognize both the raw data and the limited data with reference to the limitation report in a user terminal 502. On the other hand, a person in charge of the vendor staying in the user side can also recognize measurement data from a vendor room server 504 via an authentication server 503, but accessible measurement data is limited to the limited data.

The limited data can be accessed via the network through an authentication server 511 also in the vendor site. For example, in the vendor, a log of a maintenance work based on the limited data is analyzed by an analysis server 512, and the analysis result can be reported to the user. In such a manner, training and the like for a worker in remote locations can be realized.

The above-described embodiments and modifications have been described in detail in order to facilitate the understanding of the present invention, and the present invention is not necessarily limited to those including all of the described configurations. In addition, part of the configuration of the embodiments and a part of the configuration of the modifications can be replaced with the configurations of other embodiments and modifications, and in addition, the configuration of the embodiments and modification can also be added with the configurations of other embodiments and modifications. In addition, part of the configuration of each of the embodiments and modifications can be subjected to addition, deletion, and replacement with respect to other configurations.

### LIST OF REFERENCE SIGNS

10: path, 11: marker, 15: work area, 21: 3D sensor, 22: cable, 23: visual field, 30: worker, 31: HMD, 40: semiconductor manufacturing apparatus, 41: base plate, 42: lid, 43: valve box, 44: gate valve, 50: path model, 51: coordinate criterion, 55: work area model, 70: worker model, 81: base plate model, 82: lid model, 83: valve box model, 84: gate valve model, 100: real space, 110: virtual space, 201: processor (CPU), 202: memory, 203: storage device, 204: input interface, 205: output interface, 206: communication interface, 207: input/output port, 208: bus, 209: input device, 210: display device, 221: initial setting unit, 222: data acquiring unit, 223: object identifying unit, 224: coordinate transforming unit, 225: work determining unit, 226: region setting unit, 227: data limiting unit, 228: data outputting unit, 229: data storing unit, 301: CAD data, 302: space model, 303: work process table, 321, 322, 322′, 323, 324: ROI, 331: ID, 332: work process name, 333: determination criterion, 334: work area candidate, 335: related ROI, 336: attribute, 337: limiting mode, 350: bounding box, 401: main body part, 402: upper chamber, 403: lower chamber, 404: sample stand, 405: sample stand base, 411, 412, 413: ROI, 420: carriage, 501: data-sharing server, 502: user terminal, 503, 511: authentication server, 504: vendor room server, 512: analysis server

1. A measuring apparatus for acquiring measurement data obtained by measuring a maintenance work for a semiconductor manufacturing apparatus by a worker by using a first 3D sensor mounted in a space in which the maintenance work is performed, comprising:
an object identifying unit for identifying an object included in an image of raw data acquired from the first 3D sensor;
a coordinate transforming unit for obtaining a position in the space of an identification object identified by the object identifying unit;
a work determining unit for determining a work process executed by the worker on the basis of movements of one or more identified objects;
a region setting unit for setting a region which is permitted/prohibited to be output in the image of the raw data in accordance with the work process determined by the work determining unit; and
a data limiting unit for generating limited data obtained by making the region which is prohibited to be output by the region setting unit invisible in the image of the raw data.

2. The measuring apparatus according to claim 1, wherein an ROI having an attribute regarding permission/prohibition of outputting the image of the raw data is set in the space,
the ROI includes a first ROI having an output prohibition attribute in which outputting of the image of the raw data is always prohibited, and a second ROI in which permission and prohibition of outputting the image of the raw data can be switched, and
the region setting unit permits outputting of at least one of the second ROIs determined as related ROIs in the work process determined by the work determining unit in the image of the raw data, and prohibits outputting of the other region.

3. The measuring apparatus according to claim 2, wherein
the region setting unit switches the permission and prohibition of outputting of the second ROI in accordance with a movement of the identified object.

4. The measuring apparatus according to claim 2, wherein
the region setting unit can narrow the region of the second ROI which is permitted to be output in the image of the raw data and set the narrowed region.

5. The measuring apparatus according to claim 4, wherein
the region setting unit can narrow the region of the second ROI which is permitted to be output in the image of the raw data to a range including the identified object or a range instructed by the worker, and set the narrowed range, and
the range instructed by the worker is set by a second 3D sensor worn by the worker.

6. The measuring apparatus according to claim 2, wherein
the worker wears a second 3D sensor,
the object identifying unit identifies an object included in an image of raw data acquired from the second 3D sensor, and
the region setting unit sets a range including an identification object identified by the object identifying unit in the image of the raw data acquired from the second 3D sensor as a region which can be output.

7. The measuring apparatus according to claim 2, wherein
a carriage is used in the maintenance work, and the carriage is provided with a third 3D sensor using the top face of the carriage as a third ROI,
the object identifying unit identifies an object included in the image of raw data acquired from the third 3D sensor, and
when placement of an object on the carriage is detected, the region setting unit makes a setting of permitting the third ROI to be output in the image of the raw data acquired from the third 3D sensor.

8. The measuring apparatus according to claim 1, wherein
the region setting unit displays the raw data and the limited data so as to be comparable, and can edit an invisible region in the image of the limited data.

9. The measuring apparatus according to claim 1, wherein
the region setting unit generates a limitation report including information with respect to a process of setting an invisible region in the limited data.

10. The measuring apparatus according to claim 1, wherein
the data limiting unit applies any of black-out, blurring, and deformation to a region which is prohibited to be output by the region setting unit, in the image of the raw data.

11. A measured data utilization system comprising:
the measuring apparatus according to claim 1; and
an information processing apparatus which can be connected to the measuring apparatus via a network, wherein,
to the information processing apparatus, provision of the raw data is prohibited, and the limited data is provided.

12. An acquisition method of measured data, for acquiring measurement data obtained by measuring a maintenance work for a semiconductor manufacturing apparatus by a worker with a 3D sensor mounted in a space in which the maintenance work is performed by using a measuring apparatus, wherein
the measuring apparatus comprises an object identifying unit, a coordinate transforming unit, a work determining unit, a region setting unit, and a data limiting unit,
the object identifying unit identifies an object included in an image of raw data acquired from the 3D sensor,
the coordinate transforming unit obtains a position in the space of an identification object identified by the object identifying unit,
the work determining unit determines a work process executed by the worker on the basis of movements of the one or more identified objects,
the region setting unit sets a region which is permitted/prohibited to be output in the image of the raw data in accordance with the work process determined by the work determining unit; and
the data limiting unit generates limited data obtained by making invisible a region which is prohibited to be output by the region setting unit, in the image of the raw data.

13. The acquisition method of measured data according to claim 12, wherein
an ROI having an attribute regarding permission/prohibition of outputting the image of the raw data is set in the space,
the ROI includes a first ROI having an output prohibition attribute in which outputting of the image of the raw data is always prohibited, and a second ROI in which permission and prohibition of outputting the image of the raw data can be switched, and
the region setting unit permits outputting of at least one of the second ROIs determined as related ROIs in the work process determined by the work determining unit in the image of the raw data, and prohibits outputting of the other region.

14. A measured data utilization system comprising:
the measuring apparatus according to claim 2; and
an information processing apparatus which can be connected to the measuring apparatus via a network, wherein,
to the information processing apparatus, provision of the raw data is prohibited, and the limited data is provided.
